(19) United States
(12) Patent Application Publication
(10) Pub. No.: US 2001/0038081 A1
(43) Pub. Date: Nov. 8, 2001

(54) Circuit with an optocoupler

(75) Inventor: Erik Maria Hendrik De Wulf, Brugge (BE)

Correspondence Address: Jack E. Haken, Corporate Patent Counsel, U.S. Philips Corporation, 580 White Plains Road, Tarrytown, NY, 10591, US

(73) Assignee: KONINKLIJKE ELECTRONICS N. V.

(21) Appl. No.: 09/826,701

(22) Filed: Apr. 5, 2001

(30) Foreign Application Priority Data
Apr. 28, 2000 (EP) 00201531.1

(51) Int. Cl. G02B 27/00

(52) U.S. Cl. 250/551

(57) ABSTRACT

An optocoupler driver circuit comprises an optocoupler (OC) with a light-emitting device (D) and a photosensitive device (T). A current source (CS) supplies a current (Is) to both the light-emitting device (D) and an impedance (Z). The ratio of the current (Id) through the light-emitting device (D) and the resulting current (Ic) through the photosensitive device (T) decreases if the temperature increases. The voltage (Vd) across the light-emitting device (D) also decreases if the temperature increases. The decrease of the voltage (Vd) across the light-emitting device (D) causes the current (Iz) through the impedance (Z) to decrease. Consequently, the current (Id) through the light-emitting device (D) increases and counteracts the decreasing ratio.

The invention relates to an optocoupler driver circuit, and to a display apparatus comprising such an optocoupler driver circuit.

U.S. Pat. No. 5,734,170 discloses a driver circuit for an optocoupler which comprises a light-emitting device (further referred to as LED), and a first and a second photosensitive device both being optically coupled to the LED. A current through the LED is controlled via a main current path of a transistor to vary with an input signal supplied to a control input of the transistor. The first photosensitive device is part of a receiver circuit which supplies an output signal being in conformance with the input signal. The transfer characteristics from LED to photosensitive device are temperature-dependent. When the amount of light produced by the LED decreases due to a temperature change, the second photosensitive device which is connected to the control input of the transistor will sink less current from the control electrode. The current trough the LED increases to counteract the decreased light output caused by the temperature change. Consequently, the receiver circuit supplies, via the first photosensitive device, an output signal which is less temperature-dependent.

It is a drawback that two photosensitive devices are required in this prior art driver circuit.

It is, inter alia, an object of the invention to provide an optocoupler driver circuit with a decreased temperature sensitivity which is more efficient.

To this end, a first aspect of the invention provides an optocoupler driver circuit. A second aspect of the invention provides a display apparatus comprising such an optocoupler driver circuit. Advantageous embodiments are defined in the dependent claims.

The optocoupler driver circuit comprises a current source which supplies a current to both the light-emitting device and the impedance. The ratio of the current through the light-emitting device and the resulting current through the photosensitive device decreases if the temperature increases. Also, the voltage across the LED decreases if the temperature increases. The decrease of the voltage across the light-emitting device causes the current through the impedance to decrease. Consequently, the current through the light-emitting device increases and counteracts the decreasing ratio. This optocoupler driver circuit does not require two photosensitive devices which are optically coupled to the same LED so as to obtain a less temperature-dependent signal transfer via the optocoupler. This gives rise to a cheaper and more efficient optocoupler. The light produced by the LED need not be distributed over two photosensitive devices but can be concentrated on the single photosensitive device.

In an embodiment as claimed in claim 3, the impedance is a resistor. However, it is also possible to use a more complicated circuit behaving as an impedance. Dependent on the transfer characteristic of the optocoupler, an improved temperature compensation may be reached when the value of the impedance depends on the temperature and/or on the current through the LED.

The impedance may be arranged directly in parallel with the LED. It is also possible to arrange a component in series with the LED, and to arrange the impedance in parallel with the series arrangement. The component has preferably a temperature-dependent behavior. In an embodiment as claimed in claim 4, the component is a diode. The series arrangement of this extra diode and the diode of the LED substantially doubles the voltage change across the impedance and thus causes a stronger compensation effect.

The display apparatus as claimed in claim 5 uses the optocoupler as claimed in claim 1 to transport information (the input signal) from the signal processor to the deflection circuit with no or a minimal influence of temperature changes.

The display apparatus as claimed in claim 6 is divided into a mains-insulated part and a non-mains-insulated part. The non-mains-insulated part is inevitable because the power consumed by the display apparatus is supplied by the mains. The mains-insulated part is required to provide user touch-safe inputs and outputs in the apparatus without a need to mains-insulate all these inputs and outputs. The display apparatus comprises a signal processor at the mains-insulated part of the display apparatus, and a deflection circuit at a non-mains-insulated part of the display apparatus. This has the advantage that a simple and cheap non-mains-insulated mains power supply can be used to supply power to the deflection circuit. The signals generated by the signal processor to control the deflection cross the barrier between the mains-insulated part and the non-mains-insulated part via optocouplers as claimed in claim 1. In this way, these signals are disturbed as little as possible by the temperature dependence of the optocouplers. This is especially important if these signals are analog signals such as, for example, the East-West parabola for East-West correction, the line or frame amplitude, or other geometry (correction) waveforms or focussing waveforms generated by a geometry processor which may be part of the signal processor. The signal processor may comprise a video processor, a synchronization processor, and a geometry processor as are generally known in the art of video displays.

In an embodiment of the display apparatus as claimed in claim 8, the line output transformer which is part of the line deflection circuit has a primary winding at the non-insulated part and a secondary winding at the mains-insulated part. The primary winding is arranged in a known way in one of the conventional line deflection circuits to generate a line deflection current in the line deflection coil. As an example, the line deflection circuit may be the generally used diode modulator circuit. The secondary winding supplies a mains-insulated power supply voltage to the signal processor.

These and other aspects of the invention are apparent from and will be elucidated with reference to the embodiments described hereinafter.

In the drawings:

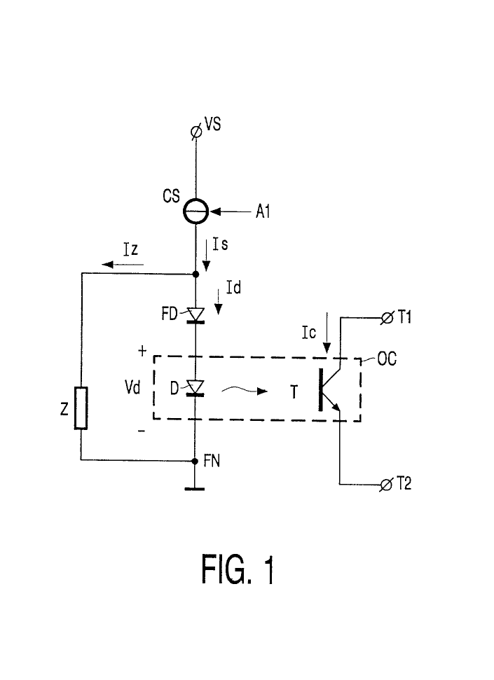

FIG. 1 shows a diagram of an optocoupler driver circuit in accordance with the invention, and

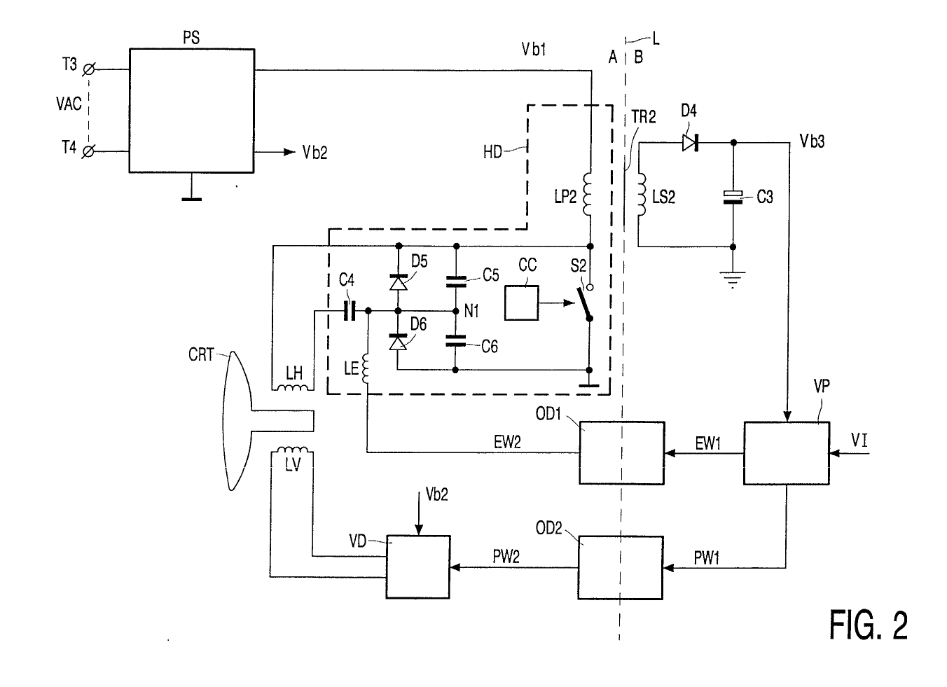

FIG. 2 shows a block diagram of an implementation of an optocoupler driver circuit in accordance with the invention in a display apparatus with a cathode ray tube.

FIG. 1 shows a diagram of an optocoupler driver circuit in accordance with the invention. An optocoupler OC comprises a photosensitive or light-sensitive device T, and a series arrangement of a diode FD and a light-emitting device D. In FIG. 1, the light-emitting device D is a light-emitting diode, and the light sensitive device T is a transistor. A controllable current source CS supplies a current Is of which a value is controlled by a control signal A1. For ease of explanation it is assumed that the current source CS is substantially temperature-compensated. Consequently, the current Is of which the value depends on the control signal A1, is substantially constant in the temperature range wherein the optocoupler circuit is used. In consumer applications, this range covers about 0 to 65 degrees centigrade, but other ranges may be required dependent on the application. Such a controllable temperature-compensated current source is well known from Integrated Circuits (ICs) and is therefor not further described. However, it is not essential for the invention that the current source CS is substantially temperature-compensated, but if a very good temperature compensation is required, the impedance might otherwise become more complicated.

The current source CS is arranged between a power supply voltage Vs and a node denoted by N. The current Is flows towards the node N. The series arrangement of the diode FD and the light-emitting diode D is connected between the nodes N and FN. Both the anode of the diode FD and the diode D is directed towards the node N. The impedance Z is connected in parallel with the series arrangement of the diodes D and FD. If the current source CS is substantially temperature-compensated, sufficient temperature compensation may be reached if the value of the impedance Z is substantially constant in the temperature range involved. This is especially the case if the transfer characteristic of the optocoupler varies linearly with the temperature in the temperature range involved. The current Is splits into a current Id through the series arrangement of the diodes D and FD, and a current Iz through the impedance Z.

The optocoupler transistor T has two terminals T1 and T2. A current Ic flows through the transistor T. The light received by the transistor T may be converted into an output signal in many ways. By way of example, a resistor may be arranged between the terminal T1 and a positive power supply voltage, and the terminal T2 may be connected to ground. An operational amplifier may sense the voltage at the terminal T1.

The circuit shown in FIG. 1 operates in the following way. The ratio of the currents Ic and Id decreases if the temperature increases. Also, the voltage Vd across the series arrangement of the diodes D and FD decreases if the temperature increases. The decrease of the voltage Vd causes the current Iz through the impedance Z to decrease. Since the current Is supplied by the current source CS is independent of the temperature, the current Id through the diode increases and counteracts the decreasing ratio of the currents Ic and Id.

The circuit shown in FIG. 1 is one possible embodiment of the invention. For example, the diodes D and Fd may be poled in the opposite direction, i.e., the current Is then has to flow in the opposite direction too. Depending on the temperature characteristic of the current transfer ratio (CTR) of the optocoupler, it is possible to omit the extra diode FD, or to add more than one diode in series with the diode D of the optocoupler, the extra diode(s) being poled in the same direction as the diode D. The impedance Z is now arranged in parallel with the series arrangement of the extra diodes and the diode D. In this way, in combination with the correct value of the impedance Z, it is possible to compensate the change of the CTR of the optocoupler as a function of temperature.

If the optocoupler current Id is applied in a wide range and the change of the CTR as a function of the temperature is not linear, the impedance Z should vary as a function of the temperature.

In a practical implementation, wherein the impedance Z is a resistor arranged in parallel with a series arrangement of the diode D and one extra diode FD, the component values are:

Z=820 ohms,

Is 3 milliamperes,

wherein the temperature dependence of the ratio is Ic/Id=−10/45 per degree centigrade, the temperature dependence of each diode D and FD is −2 millivolts per degree centigrade, and

the voltage Vd across the diode D of the optocoupler is about 1V for a TCDT1102G opto coupler from Temic or Vishay Telefinken.

FIG. 2 shows a block diagram of an implementation of an optocoupler driver circuit in accordance with the invention in a display apparatus with a cathode ray tube.

The display apparatus is divided into a mains-insulated part which is denoted by B and shown at the right-hand side of the vertical dashed line L, and a non-mains-insulated part which is denoted by A and shown at the left-hand side of the line L. The mains-insulated part B of the display apparatus comprises a signal processor VP, a secondary winding LS2 of the line output transformer TR2 (further referred to as LOT) and the mains-insulated part of the optocoupler driver circuits OD1 and OD2. The non-mains-insulated part of the display apparatus comprises the non-mains-insulated part of the optocoupler driver circuits OD1 and OD2, a line deflection circuit HD, a frame deflection circuit VD, the line and frame deflection coils LH and LV, a cathode ray tube CRT, and a non-mains-insulated mains power supply PS to supply power to the deflection circuits HD and VD. The line deflection circuit HD comprises the primary winding LP2 of the LOT.

The power supply PS comprises input terminals T3 and T4 to receive the AC mains voltage Vac, a first output supplying a power supply voltage Vb1 to the primary winding LP2, and a second output supplying a power supply voltage Vb2 to the frame deflection circuit VD. The topology of the power supply PS is not relevant to the invention. Any of the well-known non-mains-insulated power supply topologies which are able to supply at least two power supply voltages Vb1 and Vb2 can be used. For example, the power supply PS may be a down-converter wherein a secondary winding of a non-mains-insulated transformer supplies the power supply voltage Vb2.

The other end of the primary winding LP2 is connected to non-mains-insulated ground via a switching element S2 which is controlled by a control circuit CC in response to a line synchronizing signal of the video signal VI to be displayed. A series arrangement of the capacitors C5 and C6 is arranged in parallel with the switch S2, while a junction of the series arrangement is denoted by N1. A diode D5 is arranged in parallel with the capacitor C5 with its anode connected to the node N1. A diode D6 is arranged in parallel with the capacitor C6 with its cathode connected to the node N1. A series arrangement of the line deflection coil LH and an S-correction capacitor C4 is arranged in parallel with the diode D5. An East-West modulation coil LE is connected between the node N1 and the non-mains-insulated part of the optocoupler driver circuit OD1 to receive the output East-West signal EW2 which is a substantially parabola-shaped frame-frequent periodical waveform. Although the line deflection circuit HD is shown to be a simplified diode modulator, other topologies may also be implemented wherein a LOT is used which has a mains insulation between its primary winding LP2 and its secondary winding LS2. A frame deflection circuit VD receives an output signal PW2 from the non-mains-insulated part of the optocoupler OD2, the power supply voltage Vb2 to supply a frame deflection current through the frame deflection coil LV.

The secondary winding LS2 supplies a power supply voltage to the signal processor VP via the diode D4. A smoothing capacitor C3 is connected in parallel with a series arrangement of the secondary winding LS2 and the diode D4. The signal processor VP generates the East-West input signal EW1 and an input signal PW1. The East-West input signal EW1 is supplied to the mains-insulated part of the optocoupler OD1 to modulate the current through the LED of the optocoupler OD1. The input signal PW1 is supplied to the mains-insulated part of the optocoupler OD2 to modulate the current through the LED of the optocoupler OD2. The input signal PW1 is a signal determining, for example, the frame deflection current, the frame amplitude, or frame geometry correction waveforms.

In the display apparatus shown in FIG. 2, the signal processor VP controls the deflection circuits HD and VD via the barrier between the mains-insulated part and the non-mains-insulated part via optocouplers driver circuits as shown in FIG. 1, which have an improved temperature behavior. In this way, these signals are disturbed as little as possible by the temperature dependence of the optocouplers. This is especially important if these signals are analog signals such as, for example, the East-West parabola for East-West correction, the line or frame amplitude, or other geometry (correction) waveforms or focussing waveforms generated by a geometry processor which may be part of the signal processor VP.

It should be noted that the above-mentioned embodiments illustrate rather than limit the invention, and that those skilled in the art will be able to design many alternative embodiments without departing from the scope of the appended claims.

Although the optocoupler circuit is implemented in the embodiment of FIG. 2 to transfer deflection or geometry signals from the mains-insulated part of the display apparatus to the non-mains-insulated part, the invention is not limited to this use. For example, the optocoupler circuit may also be used to transfer information from the non-mains-insulated part to the mains-insulated part of the display apparatus. For example, the optocoupler circuit may be used in a mains separated switched-mode power supply to provide feedback from a power supply voltage at the non-mains-insulated part to the power supply control circuit at the mains-insulated part to stabilize the power supply voltage.

In the claims, any reference signs placed between parentheses shall not be construed as limiting the claim. The verb “to comprise” and its conjugations does not exclude the presence of elements or steps other than those stated in a claim. The invention can be implemented by means of hardware comprising several distinct elements, and by means of a suitably programmed computer. In the device claim enumerating several means, several of these means can be embodied by one and the same item of hardware.

1. An optocoupler driver circuit comprising an optocoupler (OC) comprising a light-emitting device (D) and a photosensitive device (T) being optically coupled to the light-emitting device (D), a transfer characteristic from a current (Id) through the light-emitting device (D) to a current (Ic) through the photosensitive device (T) being temperature-dependent, characterized in that said driver circuit comprises an impedance (Z) and a current source (CS) for supplying a current to a node (N), both said light-emitting device (D) and said impedance (Z) being arranged between said node (N) and a further node (FN), said impedance (Z) having a value to decrease said temperature dependence of said transfer characteristic.

2. An optocoupler driver circuit as claimed in claim 1, characterized in that the light-emitting device (D) comprises a diode, wherein the diode (D) is poled to conduct said current (Is).

3. An optocoupler driver circuit as claimed in claim 1, characterized in that said impedance (Z) is a resistor.

4. An optocoupler driver circuit as claimed in claim 2, characterized in that a further diode (FD) is arranged in series with the said first mentioned diode (D), the series arrangement being arranged between the first mentioned node (N) and the further node (FN).

5. A display apparatus comprising
an optocoupler driver circuit comprising an optocoupler (OC) comprising a light-emitting device (D) and a photosensitive device (T) being optically coupled to the light-emitting device (D), a transfer characteristic from a current (Id) through the light-emitting device (D) to a current (Ic) through the photosensitive device (T) being temperature-dependent, said driver circuit further comprising an impedance (Z), and a controllable current source (CS) for supplying a current to a node (N), both said light-emitting device (D) and said impedance (Z) being arranged between said node (N) and a further node (FN), said impedance (Z) having a value to decrease said temperature dependence of said transfer characteristic,
a signal-processing circuit (VP) for receiving a video signal to supply an input signal (EW1, PW1) to a control input of said current source (CS) to obtain a value of said current (Is) being dependent on the input signal (EW1, PW1), the photosensitive device (T) supplying an output signal (EW2, PW2) corresponding to the input signal (EW1, PW1), and
a deflection circuit (HD, VD) for receiving the output signal (EW2, PW2) to supply a drive signal to a deflection coil (LH, LV) of a cathode ray tube.

6. A display apparatus as claimed in claim 5, characterized in that the input signal (EW1, PW1) is an analog signal.

7. A display apparatus as claimed in claim 5, characterized in that the display apparatus further comprises a mains power supply (PS) for receiving an AC mains voltage to supply a power supply voltage (Vb1, Vb2) to the deflection circuit (HD, VD), the display apparatus being divided into a non-mains-insulated part and a mains-insulated part, the non-mains-insulated part comprising the power supply (PS), the deflection circuit (HD, VD), the deflection coil (LH, LV) and the photosensitive device (T), the mains-insulated part comprising the signal-processing circuit (VP), the light-emitting device (D) and said driver circuit.

8. A display apparatus as claimed in claim 7, characterized in that the deflection circuit (HD, VD) comprises a primary winding (LP2) of a line output transformer (TR2), and a controllable switch (S) for periodically connecting the power supply voltage (Vb1) to the primary winding (LP2), the line output transformer (TR2) further comprising a secondary winding (LS2) for supplying a further power supply voltage (Vb3) to the signal-processing circuit (VP), the secondary winding (LS2) being mains-insulated with respect to the non-mains-insulated primary winding (LP2).
